(19) United States
(12) Patent Application Publication
(10) Pub. No.: US 2021/0219388 A1
(43) Pub. Date: Jul. 15, 2021

(54) OIL-WATER HEAT EXCHANGER, IN PARTICULAR FOR THE INTERNAL COMBUSTION ENGINE OF A MOTOR VEHICLE

(71) Applicant: Webasto SE, Stockdorf (DE)

(72) Inventors: CHRISTIAN HAINZLMAIER, Stockdorf (DE); MARVIN LAPPE, Stockdorf (DE); CHRISTOPH CAP, Stockdorf (DE); KARL GOTTL, Stockdorf (DE); HANS RECHBERGER, Stockdorf (DE); TOBIAS HENTRICH, Stockdorf (DE)

(21) Appl. No.: 15/999,667

(22) PCT Filed: Feb. 13, 2017
(86) PCT No.: PCT/EP2017/053111

§ 371 Date: Aug. 20, 2018

(30) Foreign Application Priority Data
Feb. 18, 2016 (DE) 10 2016 102 890.8

(51) Int. Cl. H05B 3/26; F01P 3/00; C23C 4/01

(52) U.S. Cl. CPC H05B 3/262; F01P 3/00; C23C 4/01; F28F 13/12; H05B 2203/017; H05B 2203/013; F01P 2003/008

(57) ABSTRACT

The invention relates to an oil-water heat exchanger, in particular for connection to an internal combustion engine of a motor vehicle, comprising at least one electric heating coating (13) which is applied to an outer side and/or in the interior of the heat exchanger.

The invention relates to an oil-water heat exchanger according to Claim 1 and to a method for producing an oil-water heat exchanger according to Claim 11.

For example, EP 2 466 241 A1 describes an oil-water heat exchanger having multiple trough elements stacked one on top of the other and soldered to one another. Such oil-water heat exchangers are commonly integrated into the cooling circuit of internal combustion engines and may be used for example for cooling the engine oil.

A further oil-water heat exchanger is presented in US 2015/0176913 A1. In a particular embodiment, said document proposes an electric heater in an interior space of the heat exchanger for the purposes of warming one of the fluids that interact with one another in the heat exchanger.

In the case of the known oil-water heat exchangers, it is basically perceived to be disadvantageous that, in these, preheating is either not possible at all, or is possible only with relatively great outlay and in an ineffective manner (in particular slowly). In particular, the reduction of pollutants that form when the engine oil is not at operating temperature is considered to be in need of improvement.

With regard to the prior art, reference is basically also made to WO 2013/186106 A1 and WO 2013/030048 A1. Said documents describe heaters which have an electric heating layer which warms when an electrical voltage is applied (or when a current flows).

It is therefore an object of the invention to warm the oil of an oil-water heat exchanger in a simple and reliable manner, such that the formation of pollutants can be reduced.

Said object is achieved by means of the features of claim 1.

In particular, the object is achieved by means of an oil-water heat exchanger, in particular for connection to an internal combustion engine, comprising at least one electric heating coating which is applied to an outer side and/or in the interior of the heat exchanger.

A core concept of the invention lies in using the electric heating coatings known per se from WO 2013/186106 A1 or WO 2013/030048 A1 (an electric heating coating will hereafter be referred to for short as “heating coating”) in or on an oil-water heat exchanger. Here, it has surprisingly been found that (even in the case of low-voltage applications—in particular lower than 100 V—of for example 12 or 24 or 28 volts) satisfactory and in particular rapid warming of the oil can be realized. The need for a separate heater (as proposed for example in US 2015/0176913 A1) is thus eliminated. This reduces production costs and the structural space of the oil-water heat exchanger. In particular in the low-voltage application (in particular lower than 100 V), it is also thus possible to ensure relatively inexpensive production, such that there is no need for such “exactness” as in the case of high-voltage applications (as described for example in WO 2013/186106 A1). Furthermore, a shielding (insulation to the outside) of the electric heating coating can possibly be omitted entirely in the present usage situation.

In a first embodiment, the heating coating is applied indirectly, in particular over an insulation layer, to the oil-water heat exchanger. An insulation layer of said type may for example be formed by an adhesion promoter layer or attached by means of an adhesion promoter layer of said type to the oil-water heat exchanger. For the insulation layer, use may preferably be made of a polymer material or a ceramic material (e.g. Al₂O₃). The insulation layer is however preferably provided by a passivation, in particular an oxidization, in particular anodization (of aluminium or of an aluminium alloy). The underlying surface may possibly be the housing of the oil-water heat exchanger, in particular a cover. Altogether (specifically in low-voltage applications), a simple and nevertheless adequate electrical insulation is provided. Alternatively, the heating coating may even be applied directly to the oil-water heat exchanger, in particular to a housing of the oil-water heat exchanger (for example in low-voltage applications and/or if the underlying surface is not electrically conductive or only poorly electrically conductive). The heating coating and/or insulation layer is preferably applied to the oil-water heat exchanger over the (full) surface. The heating coating and/or the insulation layer may furthermore have an (at least substantially) constant layer thickness. The heating coating or the insulation layer may be applied directly to the oil-water heat exchanger. The heating coating and/or the insulation layer may be inherently of dimensionally unstable (or non-self-supporting) design. A substrate can be omitted, such that the heating coating (and optional insulation layer) is possibly formed without a substrate. A carrying and/or support structure that may be required can be provided by the oil-water heat exchanger. Altogether, a complex construction comprising a heating layer, a cumbersome insulating layer and an additional adhesion promoter layer, can be avoided. The heating coating may basically be connected cohesively to a surface or to an inner surface of the oil-water heat exchanger.

The heating coating is particularly preferably designed for operation in the low-voltage range, preferably for 12 volts, 24 volts or 48 volts. Corresponding electrical and/or electronic components of the oil-water heat exchanger are then preferably likewise designed for such a low-voltage range (12 volts, 24 volts or 48 volts). In particular in the case of an application in the low-voltage range, effective preheating can be realized in a synergistic manner using simple means. The “low-voltage range” is to be understood preferably to mean an operating voltage of lower than 100 V, in particular lower than 60 V (direct current).

In one specific embodiment, the heating coating is arranged on a heat exchanger cover of the oil-water heat exchanger. The heating coating may possibly be arranged on (applied to) an outer side of the heat exchanger cover (alternatively on an inner side). Specifically in the case of a low-voltage application, even in the case of an arrangement on the outer side of the cover (which may be advantageous for example with regard to the contacting), adequately safe use of the oil-water heat exchanger (even without a further protective element) is possible. Altogether, in this way, a simple and nevertheless reliably functioning structure is proposed.

In an alternative embodiment, the heating coating is formed as a continuous (in particular unstructured and/or uninterrupted) layer. The heating coating may generally have at least one section within which, in two mutually perpendicular directions, there are no interruptions in the heating coating over a distance of at least 1 cm, preferably at least 2 cm, even more preferably at least 4 cm. For example, the heating coating may comprise at least one rectangular section with a length and a width of in each case at least 1 cm, preferably at least 2 cm, even more preferably at least 4 cm, within which there are no interruptions or possible other structures in the heating coating. An “interruption” within the heating coating is to be understood to mean a section through which no current can flow, for example because said section remains (entirely) free from material and/or is (at least partially) filled by an insulator. The heating coating may be (thermally) sprayed on (regardless of whether it is unstructured or structured in the final state). In this context, it has surprisingly been found that even a heating coating of such simple form can realize adequate warming of the oil.

In a further alternative embodiment, the heating coating is formed as a structured layer. The heating coating is in this case preferably structured by means of a masking process (preferably using silicone, which can be stamped). Such known masking processes permit satisfactory structuring and are less cumbersome than, for example, laser methods for structuring, which are used specifically in the high-voltage range. Altogether, therefore, the advantages of a masking process are utilized in a synergistic manner with regard to the present heating coating.

The above-described insulating layer may have a thickness of at least 50 μm, preferably at least 200 μm and/or at most 1000 μm, preferably at most 500 μm.

The heating coating preferably has a height (thickness) of at least 5 μm, preferably at least 10 μm and/or at most 1 mm, preferably at most 500 μm, even more preferably at most 30 μm, even more preferably at most 20 μm. A conductor track defined by the heating coating may be at least 1 mm, preferably at least 3 mm, even more preferably at least 5 mm, even more preferably at least 10 mm, even more preferably at least 30 mm wide. The expression “width” is to be understood to mean the extent of the conductor track perpendicular to its longitudinal extent (which normally also defines the direction of the current flow).

In an alternative embodiment, a protective cover, for example a silicone protective layer, is applied over the heating coating. It is however alternatively also possible (in an embodiment which is particularly easy to produce) for the heating coating to define an outer side of the oil-water heat exchanger.

In a specific embodiment, the oil-water heat exchanger has multiple modules, in particular trough elements, which may furthermore preferably be designed as described in EP 2 466 241 A1. The oil-water heat exchanger may basically (aside from the heating coating according to the invention) be designed as described in EP 2 466 241 A1 or US 2015/0176913 A1. The disclosure of these documents is hereby expressly incorporated by reference. If multiple modules are provided, at least one heating coating may be arranged between two modules. If the oil-water heat exchanger comprises multiple trough elements, at least one heating coating may possibly be arranged (applied) between two of these trough elements (on one of the trough elements). In this way, the preheating (auxiliary heating) can be further improved using simple means.

The oil-water heat exchanger may have a turbulator. In such a case, the turbulator may be formed close to, for example no further than 5 cm, in particular 2 cm, from a heating coating, and/or equipped with a heating coating. This, too, is a further possibility for improving the warming of the fluid in a simple manner (specifically without the provision of further components). Here, in a synergistic manner, use is made of the fact that an increased heat transfer is possible in the region of a turbulator owing to the turbulence that is generated.

The above object is furthermore achieved by means of a method for producing an oil-water heat exchanger, comprising the steps: providing an oil-water heat exchanger, in particular of the type described above (initially without the features relating to the heating coating), and applying an electric heating coating to the oil-water heat exchanger (directly or indirectly coating the oil-water heat exchanger with the electric heating coating). Between the two abovementioned steps, the application of an insulation layer to the oil-water heat exchanger can be performed (or the oil-water heat exchanger can be directly or indirectly coated with the insulating layer), for example by means of a passivation (oxidation, in particular anodization) of an underlying surface, for example of a heat exchanger housing. The electric heating coating may possibly be (thermally) sprayed on. Where features relating at least also to the production of the oil-water heat exchanger are described further above (in conjunction with the oil-water heat exchanger), these method features are also proposed as preferred embodiments of the method.

The above-stated object is furthermore achieved through the use of an oil-water heat exchanger of the type described above or produced in accordance with the above-described method as an oil-water heat exchanger, in particular for a motor vehicle internal combustion engine. Specifically, the oil-water heat exchanger may be used for the warming (pre-warming or auxiliary warming) of the oil, for example engine oil.

Further embodiments emerge from the subclaims.

In general, the insulating layer may be a ceramic material or a polymer material or may be composed of such a material, wherein, as ceramic material, use is made for example of Al₂O₃.

The heating layer may be applied for example in a plasma coating process, in particular plasma spraying, or in a screenprinting process or as a resistance paste, in particular to the insulating layer. In the plasma coating process, it is for example firstly possible for an electrically conductive layer to be applied, in particular to the insulating layer. Regions may subsequently be cut out of the electrically conductive layer, such that a conductor track or multiple conductor tracks are left behind. Use is however preferably made of a masking technique. The conductor tracks may then form the heating resistor or multiple heating resistors. As an alternative to a masking technique, the stated regions may for example be cut out of the conductive layer by means of a laser. The heating coating may for example be a metal layer and possibly comprise nickel and/or chromium, or be composed of said materials. For example, use may be made of 70-90% nickel and 10-30% chromium, wherein a ratio of 80% nickel and 20% chromium is considered to be highly suitable.

The heating coating may for example cover an area of at least 5 cm², preferably at least 10 cm² and/or at most 200 cm², preferably at most 100 cm². The oil-water heat exchanger may have a total volume of preferably at least 200 cm³, even more preferably at least 500 cm³, even more preferably at least 800 cm³ and/or at most 5000 cm³, preferably at most 2000 cm³. For example, the oil-water heat exchanger may be 15-25 cm long and/or 8-12 cm wide and/or 3-7 cm tall (thick).

The oil-water heat exchanger preferably has one or more first fluid channels for conducting the oil and one or more second fluid channels for conducting the water.

For control, in particular closed-loop control, of the electric heating coating, it is possible for a bimetal switch, possibly with two redundant switch devices, to be provided.

The invention will be described below on the basis of exemplary embodiments, which will be discussed in more detail on the basis of the figures. In the figures:

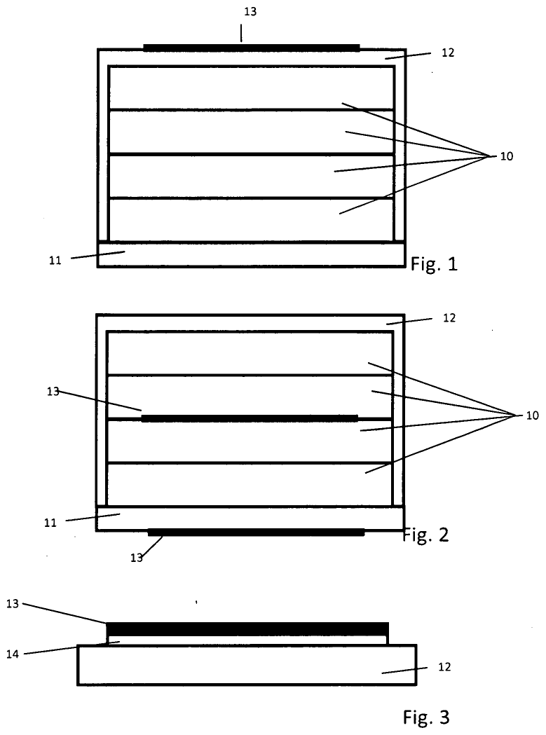

FIG. 1 shows a schematic side view of a first oil-water heat exchanger;

FIG. 2 shows a schematic view of a second embodiment of the oil-water heat exchanger; and

FIG. 3 is a schematic illustration of the electric heating coating on an underlying surface.

In the following description, the same reference designations will be used for identical parts and parts of identical action.

FIG. 1 shows, in a schematic view, an oil-water heat exchanger (which may be designed for example in detail as described in EP 2 466 241 A1) having multiple (soldered-together) trough elements 10, a base 11 and a cover 12. An electric heating coating 13 is arranged on the cover 12.

In the alternative embodiment as per FIG. 2, two electric heating coatings 13 are provided, specifically on the one hand on the base 11 and on the other hand between two trough elements 10. Other embodiments are conceivable, for example heating coatings on the cover and base or only in the interior of the heat exchanger, possibly between two troughs 10.

FIG. 3 is a schematic illustration of the electric heating coating on an underlying surface, specifically (for example) the cover 12. To produce the structure as per FIG. 3, the cover 12 is firstly produced with a passivation layer (by oxidation or anodization). The electric heating coating 13 is then applied to the insulating layer 14, for example by being (thermally) sprayed on.

It is pointed out at this juncture that all of the above-described parts both individually and in any combination, in particular the details illustrated in the drawings, may be claimed as being essential to the invention. Modifications in relation to this are familiar to a person skilled in the art.

### REFERENCE DESIGNATIONS

10 Trough element

11 Base

12 Cover

13 Electric heating coating

14 Insulating layer

1. An oil-water heat exchanger for connection to an internal combustion engine of a motor vehicle, comprising at least one electric heating coating which is applied to an outer side and/or in the interior of the heat exchanger.

2. The oil-water heat exchanger according to claim 1, wherein the heating coating is applied directly to the oil-water heat exchanger or is applied indirectly to the oil-water heat exchanger over an insulating layer, wherein the insulating layer is provided by passivation, in particular oxidization or anodization, of the underlying surface.

3. The oil-water heat exchanger according to claim 1, wherein the heating coating is designed for operation in the low-voltage range, the low voltage range being one of 12 volts, 24 volts or 48 volts.

4. The oil-water heat exchanger according to claim 1, wherein the heating coating is arranged on a heat exchanger cover of the oil-water heat exchanger.

5. The oil-water heat exchanger according to claim 1, wherein the heating coating is formed as a continuous layer.

6. The oil-water heat exchanger according to claim 1, wherein the heating coating is formed as a structured layer.

7. The oil-water heat exchanger according to claim 1, wherein the heating coating has a height between at least 5 μm and at most 30 μm and/or a conductor track defined by the heating coating is at least 3 mm.

8. The oil-water heat exchanger according to claim 1, wherein a protective coating is applied over the heating coating, or the heating coating defines an outer side of the oil-water heat exchanger.

9. The oil-water heat exchanger according to claim 1, wherein the oil-water heat exchanger has multiple modules, in particular multiple trough elements, wherein at least one heating coating is arranged between two modules, in particular trough elements.

10. The oil-water heat exchanger according to claim 1, wherein a turbulator with an electric heating coating is provided.

11. A method for producing an oil-water heat exchanger, in particular according to claim 1, comprising the steps:
providing an oil-water heat exchanger, and
applying an electric heating coating to the oil-water heat exchanger.

12. Use of an oil-water heat exchanger according to claim 1, as an oil-water heat exchanger in a motor vehicle for the internal combustion engine of a motor vehicle.

13. The oil-water heat exchanger according to claim 2, wherein the insulating layer is provided by passivation oxidization or anodization, of the underlying surface.

14. The oil-water heat exchanger according to claim 1, wherein the heating coating is formed as a thermally sprayed-on layer.

15. The oil-water heat exchanger according to claim 1, wherein the heating coating is structured with a masking process.

16. The oil-water heat exchanger according to claim 1, wherein the heating coating has a height between at least 10 μm and at most 20 μm, and/or a conductor track defined by the heating coating is preferably at least 10 mm wide.

17. The oil water heat exchanger according to claim 1, wherein the conductor track defined in the heating coating is at least 30 mm wide.

18. The oil-water heat exchanger according to claim 1, wherein the oil-water heat exchanger has multiple trough elements, and wherein at least one heating coating is arranged between two trough elements.
